(19) United States
(12) Patent Application Publication
(10) Pub. No.: US 2005/0159687 A1
(43) Pub. Date: Jul. 21, 2005

(54) Massaging apparatus

(75) Inventor: Akihiro Mizuuchi, Hikone-shi (JP)

Correspondence Address: GREENBLUM & BERNSTEIN, P.L.C., 1950 ROLAND CLARKE PLACE, RESTON, VA, 20191, US

(73) Assignee: Matsushita Electric Works, Ltd., Osaka (JP)

(21) Appl. No.: 11/028,235

(22) Filed: Jan. 4, 2005

(30) Foreign Application Priority Data
Jan. 19, 2004 (JP) 2004-010447

(51) Int. Cl. A61H 15/00; A61H 1/00

(52) U.S. Cl. 601/73; 601/119

(57) ABSTRACT

A massaging apparatus includes a grip portion to be gripped by a user, and a head portion provided on a top end of the grip portion. The head portion is provided with a vibration generator for generating a vibration to vibrate the head portion. The head portion is further provided with a massaging roller and a stimulating portion for giving a finger-press-like sensation to the user. The stimulating portion faces in the same direction as the massaging roller. With the construction, the user can instantaneously switch over the massaging roller and the stimulating portion without rotating the head portion of the apparatus.

### BACKGROUND OF THE INVENTION

1. Field of the Invention

The present invention relates to a hand-held massaging apparatus that enables a user to massage his or her body by making a vibrating head portion of the apparatus press contact with a target local part of his or her body.

2. Description of the Related Art

Heretofore, as shown in FIG. 6, a massaging apparatus 4 as disclosed in Japanese Unexamined Patent Publication No. 9-108286 is known. The apparatus 4 comprises a grip portion 1 and a head portion 3 interlocked to each other via an interlocking portion 2. The head portion 3 has a vibration generator. A massaging roller pair 5 is provided on a side wall of the head portion 3, and a protruding portion 6 is provided on the opposite side wall thereof for giving a finger-press-like sensation to a user.

In the massaging apparatus 4, when the user wishes to massage his or her shoulder, the user can massage the shoulder by holding the grip portion 1 with his or her hand and pressingly sliding the massaging roller 5 in forward and backward directions over the shoulder.

Further, the user can massage his or her shoulder locally by pivotally rotating the head portion 3 along with the interlocking portion 2 by 180 degrees in the direction shown by the arrow R in FIG. 6 and by pressing the stimulating portion 6 against the local part of the shoulder.

In the above construction disclosed in the publication, the switching operation between the massaging roller 5 and the protruding portion 6 is cumbersome, because the user has to rotate the head portion 3 by 180 degrees.

### SUMMARY OF THE INVENTION

It is an object of the present invention to provide a massaging apparatus which is free from the problems residing in the prior art.

According to an aspect of the present invention, a massaging apparatus includes a grip portion to be gripped by a user, and a head portion provided on a top end of the grip portion. The head portion is provided with a vibration generator for generating a vibration to vibrate the head portion. The head portion is further provided with a massaging roller and a stimulating portion for giving a finger-press-like sensation to the user. The stimulating portion faces in the same direction as the massaging roller.

With the construction, the user can instantaneously switch over the massaging roller and the stimulating portion without rotating the head portion of the apparatus.

These and other objects, features and advantages of the present invention will become more apparent upon reading of the following detailed description along with the accompanying drawings.

### BRIEF DESCRIPTION OF THE DRAWINGS

FIG. 1A is a side view of a massaging apparatus according to an embodiment of the present invention.

FIG. 1B is a cross-sectional side view of the massaging apparatus.

FIGS. 2A, 2B, and 2C are a front view of the massaging apparatus, a top plan view of the massaging apparatus, and a cross-sectional view of a massaging roller pair of the massaging apparatus, respectively.

FIGS. 3A, 3B, and 3C are illustrations showing exemplified states as to how the massaging apparatus is used, wherein FIG. 3A shows how a shoulder of a user is massaged, FIG. 3B shows how the neck of the user is massaged, and FIG. 3C shows how the shoulder of the user is massaged by a stimulating portion.

FIGS. 4A, 4B, and 4C are illustrations showing exemplified states as to how the massaging apparatus is used, wherein FIG. 4A shows how an arm of the user is massaged, FIG. 4B shows how the back of the user is massaged, and FIG. 4C shows how a hip of the user is massaged.

FIGS. 5A and 5B are illustrations showing exemplified states as to how the massaging apparatus is used, wherein FIG. 5A shows how a leg of the user is massaged, and FIG. 5B shows how a foot sole of the user is massaged.

FIG. 6 is a perspective view of a conventional massaging apparatus.

### DETAILED DESCRIPTION OF THE PREFERRED EMBODIMENTS OF THE INVENTION

In the following, preferred embodiments of the present invention are described referring to the accompanying drawings.

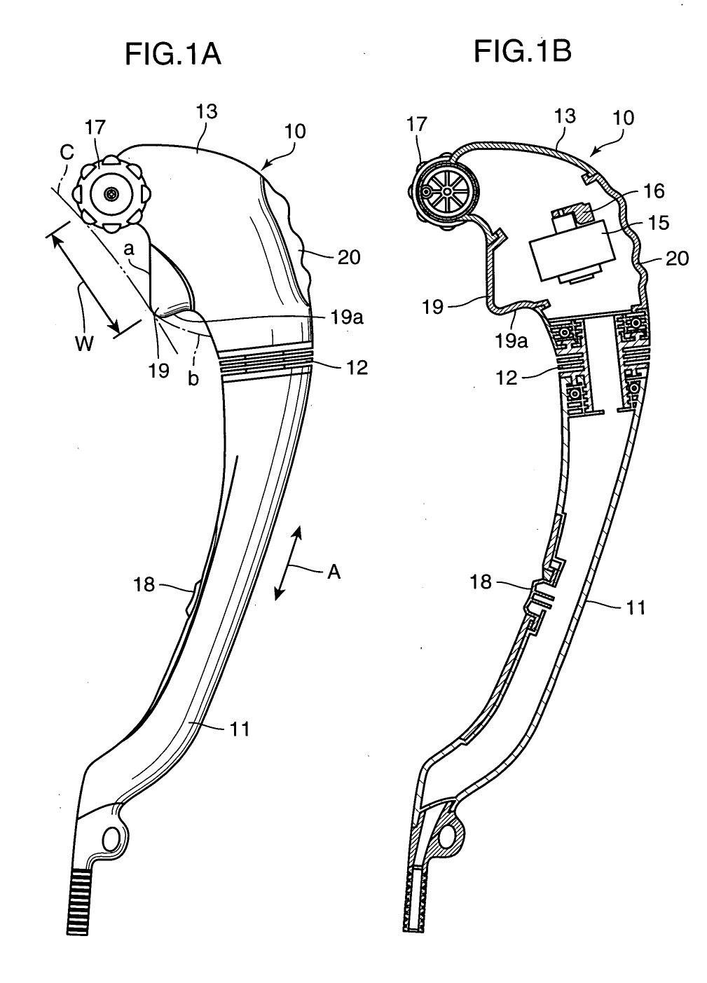

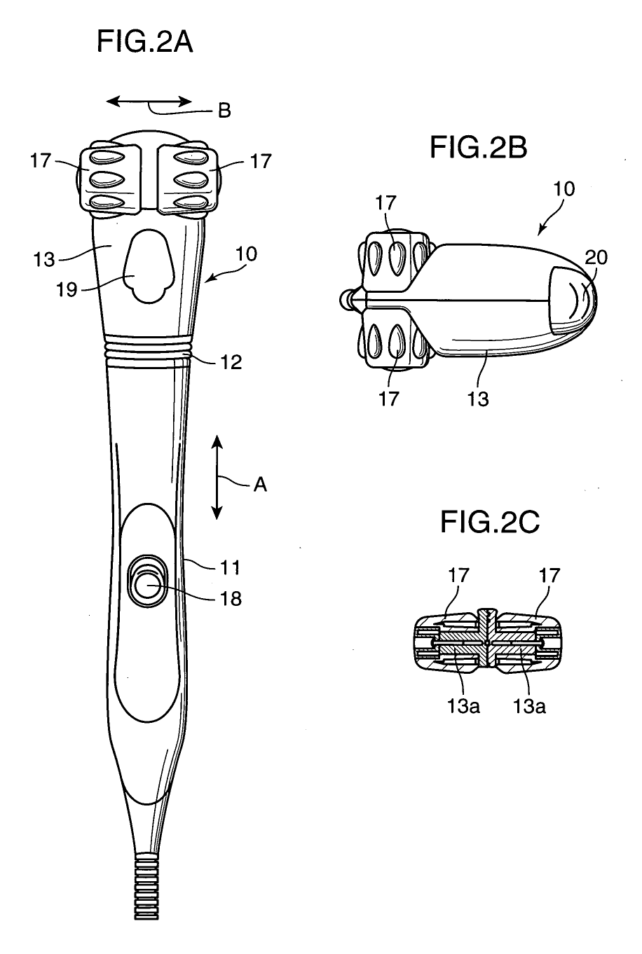

Referring to FIGS. 1A and 1B showing a side view and a cross-sectional side view of a massaging apparatus according to an embodiment of the present invention, and FIGS. 2A, 2B, and 2C showing a front view of the massaging apparatus, a top plan view of the massaging apparatus, and a cross-sectional view of a massaging roller pair of the massaging apparatus, respectively, a massaging apparatus 10 comprises a grip portion 11, a resilient interlocking portion (interlocking portion) 12, and a head portion 13, with its entirety having such a contour as to follow the curve of a human body.

The grip portion 11 has such an elongated shape that a user can easily grip with his or her hand. The head portion 13 has a relatively short length with a sufficiently large width. The grip portion 11 and the head portion 13 are made integral by interlocking an upper end part of the grip portion 11 and a lower end part of the head portion 13 by the resilient bellow-like interlocking portion 12. The resilient interlocking portion 12 is adapted to easily oscillate or vibrate the head portion 13, and to suppress the vibrations of the head portion 13 from being transmitted to the grip portion 11.

As shown in FIG. 1B, an electric motor 15 is fixedly mounted in the head portion 13. An eccentric weight 16 is attached to an output shaft of the electric motor 15. When power is supplied to the electric motor 15, the head portion 13 is oscillated or vibrated by eccentric rotation of the eccentric weight 16. The power of the electric motor 15 is changeable into 3 stages, namely, OFF, WEAK, and STRONG by a switch 18 provided on an inner curved wall of the grip portion 11.

As shown in FIG. 2A, a pair of massaging rollers 17, 17 opposed to each other with respect to operating directions of the grip portion 11 shown by the arrows A are provided at an upper part on an inner curved wall of the head portion 13. Each of the massaging rollers 17, 17 is rotatable about an axis of rotation shown by the arrows B. The axial direction B of the massaging roller 17 is substantially orthogonal to the operating direction A of the grip portion 11. As shown in FIG. 2C, the massaging rollers 17, 17 are rotatably engaged with a pair of outwardly projecting shaft portions 13a, 13a in the axial directions B, respectively. With this arrangement, the massaging rollers 17, 17 are kept from slipping out of the shaft portions 13a, 13a.

An outwardly protruding stimulating portion 19 having a mountain-like shape in side view is formed at a lower part on the inner curved wall of the head portion 13 to impart a finger-press-like sensation to a user.

The massaging roller pair 17, 17, and the stimulating portion 19 are provided on the same side of the head portion 13, namely, on the inner curved wall of the head portion 13 in such a manner that they are spaced apart from each other by a predetermined distance W (see FIG. 1A) in the operating direction A of the grip portion 11. In other words, the massaging roller pair 17, 17, and the stimulating portion 19 are aligned on an imaginary curved line C shown in FIG. 1A, which follows the curve of the user's body (e.g., the shoulder) in massaging the body with the massaging apparatus 10. The distance W preferably ranges from about 70 to 80 mm. If the distance W is shorter than the lower limit, it is highly likely that the stimulating portion 19 may undesirably contact the user's body while the user uses the massaging roller pair 17, 17 exclusively. On the other hand, if the distance W is longer than the upper limit, an instantaneous switching operation between the massaging roller pair 17, 17, and the stimulating portion 19 is difficult, which will be described later.

The stimulating portion 19 has a substantially right angled triangle in side view, with a bottom portion thereof constituting part of the inner curved wall of the head portion 13. A substantially right angled part in side view (rise-up part) of the stimulating portion 19 serves as a hook part 19a. The hook part 19a is so designed as to exert a possible maximal external force to a desired local part of the user's body in response to a user's downward pulling operation of the grip portion 11 in the operating direction A. It is possible to form a hook part having such a configuration as to exert a possible maximal external force in response to a user's upward pushing operation of the grip portion 11 in the operating direction A.

Specifically, if the stimulating portion 19 has a substantially isosceles triangle in side view, with a bottom portion thereof constituting part of the inner curved wall of the head portion 13 (see the solid line a and the one-dotted-chain line b in FIG. 1A), the stimulating portion 19 may be slipped over the user's shoulder without being pressed against a local part of the shoulder in response to a users pulling/pushing operation of the grip portion 11 in the operating directions A. This arrangement makes it difficult to transmit an external force from the grip portion 11 to the stimulating portion 19.

On the other hand, the hook part 19a of the stimulating portion 19 is advantageous in allowing the user to transmit an external force from the grip portion 11 to the stimulating portion 19 because the hook part 19a is desirably pressed against a local part of the shoulder or a like site in response to a user's pulling operation of the grip portion 11. Alternatively, the stimulating portion 19 may have a substantially quarter circle in side view, in place of the substantially right angled triangle in side view. Namely, as far as the stimulating portion 19 is easily pressed against a local part of the shoulder or a like site in response to a user's pulling or pushing operation of the grip portion 11 in the operating directions A, the stimulating portion 19 is not limited into the specific shapes.

A serrated portion 20 is formed in a lower part on an outer curved wall of the head portion 13. The serrated portion 20 substantially extends in the operating directions A of the grip portion 11.

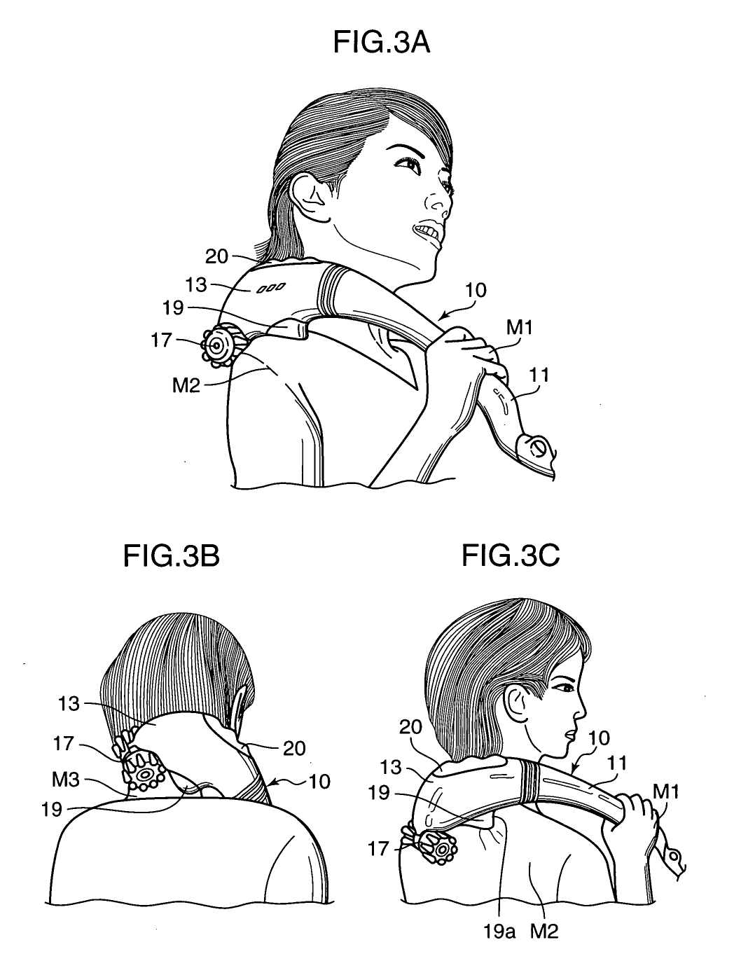

In the massaging apparatus 10 having the above construction, as exemplarily shown in FIG. 3A, a user can massage her shoulder M2 by gripping the grip portion 11 with her hand M1 and pressingly sliding the massaging roller pair 17, 17 over the shoulder M2. While the user extensively massages the shoulder M2 with the massaging roller pair 17, 17, it is possible for the user to simultaneously and locally massage a specific part of the shoulder M2 with use of the stimulating portion 19 to give a finger-press-like sensation.

Further, as exemplarily shown in FIG. 3B, the user can massage her neck M3 with use of the massaging roller pair 17, 17. While the user extensively massages the neck M3 with use of the massaging roller pair 17, 17, it is possible for the user to simultaneously and locally massage a specific part of the neck M3 with use of the stimulating portion 19 to give a finger-press-like sensation.

Furthermore, as exemplarily shown in FIG. 3C, the user can massage her shoulder M2 locally with use of the stimulating portion 19. In this case, an effective finger-press-like sensation at the local part of the shoulder M2 is obtainable by sliding the grip portion 11 in such a direction as to place the massaging roller pair 17, 17 onto the back of the user away from the shoulder M2, because the state of the massaging apparatus 10 as exemplarily shown in FIG. 3C enables the user to easily transmit an external force to the stimulating portion 19 from the grip portion 11.

In the case where the user wishes to locally massage a specific part of the shoulder M2 while extensively massaging the shoulder M2 with use of the massaging roller pair 17, 17 (see FIG. 3A), as shown in FIG. 3C, the user can instantaneously start local massaging of the shoulder M2 with use of the stimulating portion 19 to give a finger-press-like sensation to the specific part of the shoulder M2 by merely sliding the grip portion 11 in such a direction as to place the massaging roller pair 17, 17 onto the back of the user away from the shoulder M2, and by pressing the stimulating portion 19 against the specific part of the shoulder M2.

In this way, the massaging apparatus 10 provides improved operability by allowing the user to instantaneously switch over the operation between the massaging roller pair 17, 17, and the stimulating portion 19 by merely sliding the grip portion 11, without rotating the head portion, as required in the conventional massaging apparatus.

In the embodiment, since the switching operation between the massaging roller pair 17, 17, and the stimulating portion 19 is implemented by merely sliding the grip portion 11, a mechanism for pivotally rotating the head portion 13 is not required. Thus, the massaging apparatus 10 has a simplified construction, thereby contributing to production cost reduction.

Further, as mentioned above, since the stimulating portion 19 has the hook part 19a which is pressed against a local part of the shoulder M2 in response to a user's downward pulling operation of the grip portion 11, an external force is easily transmitted from the grip portion 11 to the stimulating portion 19 while the user pulls the grip portion 11 downwardly. Thus, an effective finger-press-like sensation is obtainable at a desired local part of the shoulder M2.

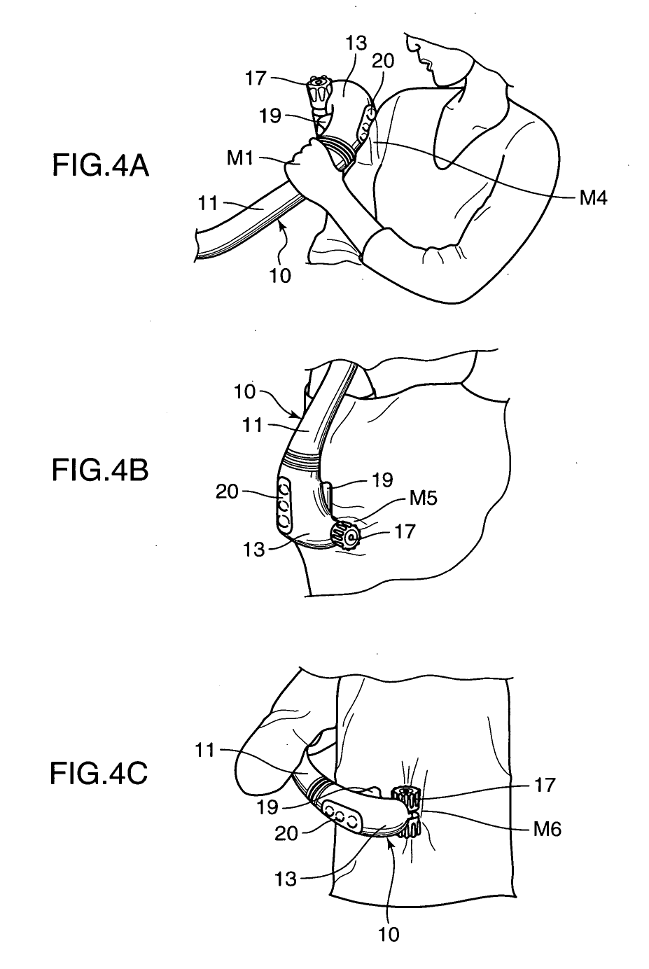

Further, as exemplarily shown in FIG. 4A, the user can massage her arm M4 with use of the serrated portion 20.

Furthermore, as exemplarily shown in FIG. 4B, the user can massage her back M5 with use of the massaging roller pair 17, 17. While the user extensively massages the back M5 with use of the massaging roller pair 17, 17, it is possible for the user to simultaneously and locally massage a specific part of the back M5 with use of the stimulating portion 19 to give a finger-press-like sensation to the specific part of the back M5.

Further, as exemplarily shown in FIG. 4C, the user can massage her hip or loins M6 with use of the massaging roller pair 17, 17. While the user extensively massages the hip or loins M6 with use of the massaging roller pair 17, 17, it is possible for the user to simultaneously and locally massage a specific part of the hip or loins M6 with use of the stimulating portion 19 to give a finger-press-like sensation to the specific part of the hip or loins M6.

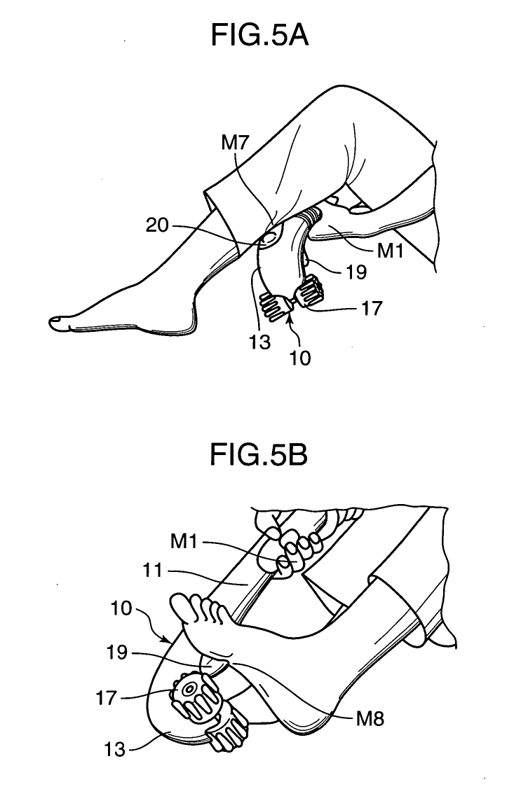

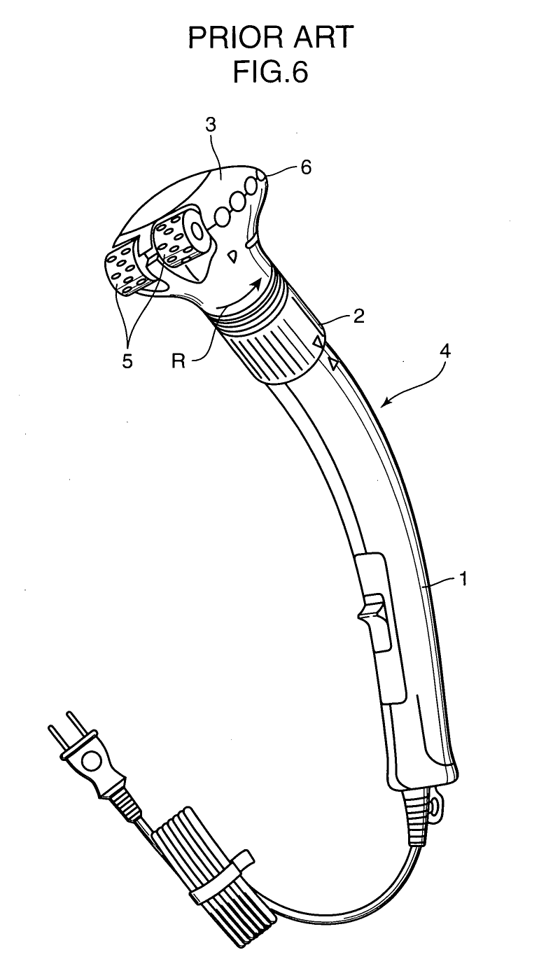

Further, as exemplarily shown in FIG. 5A, the user can massage her leg M7 with use of the serrated portion 20.

Further, as exemplarily shown in FIG. 5B, the user can massage a specific part of her foot sole M8 with use of the stimulating portion 19 to give a finger-press-like sensation to the specific pat of the foot sole M8.

The pair of massaging rollers 17, 17 is suitable for massaging a relatively large region of the user's body such as the shoulder M2, the neck M3, the back M5, and the hip/loins M6 to give a rubbing sensation to the user. The stimulating portion 19 is suitable for massaging a local part of the shoulder M2, for instance, where the user feels severe stiffness or tension. The serrated portion 20 is suitable for massaging the arm M4, the leg M7, and the foot sole M8, for instance, where it is conceived that blood circulation is poor. It is needless to say that the user can optionally use these massaging elements 17, 19, and 20 for massaging a desired site of the body, according to needs.

In the embodiment, the entirety of the massaging apparatus 10 has such a contour as to follow the curve of a human body. Alternatively, the entirety of the massaging apparatus 10 may have a substantially linear shape.

Further, it is possible to color the grip portion 11, the interlocking portion 12, and a main body of the head portion 13 in black, and to color the massaging region including the massaging roller pair 17, 17, the stimulating portion 19, and the serrated portion 20 in bright yellow-green, for instance. Such a colored massaging apparatus provides improved operability, because the user can recognize the massaging region at a glance.

As described above, an inventive massaging apparatus comprises: a grip portion to be gripped by a user; and a head portion provided on a top end of the grip portion. The head portion is provided with: a vibration generator for generating a vibration to vibrate the head portion; a massaging roller; a stimulating portion for giving a finger-press-like sensation to the user, the stimulating portion facing in the same direction as the massaging roller and being spaced apart from each other by a predetermined distance in an operating direction of the grip portion.

The head portion may preferably include a pair of massaging rollers, the respective axes of the massaging rollers being arranged in a direction perpendicularly intersecting the operating direction of the grip portion.

The massaging roller may be preferably arranged above the stimulating portion.

The most protruding point of the massaging roller and the most protruding point of the stimulating portion may be preferably made to bear on an imaginary body line.

The stimulating portion may preferably have a hook part for allowing the user to exert an external force to a local part of the user's body in response to a user's pulling operation of the grip portion in the operating direction.

With these constructions, the massaging roller and the stimulating portion are arranged on the same side of the head portion where the vibration generator is provided in such a manner that they are spaced apart from each other by the predetermined distance in the operating direction of the grip portion. When the user wishes to massage a local part of his or her shoulder, for example, while extensively massaging the shoulder with use of the massaging roller, the user can start the local massaging instantaneously by sliding the grip portion in such a direction as to place the massaging roller away from the shoulder and by pressing the stimulating portion against the local part of the shoulder.

The above arrangement allows the user to instantaneously switch over the operation between the massaging roller and the stimulating portion merely by a sliding operation of the grip portion without a pivotal rotation of the head portion, as required in the conventional apparatus. Thus, the operability of the massaging apparatus is remarkably improved.

Further, since a mechanism for pivotally rotating the head portion is not required, the massaging apparatus having a simplified construction can be produced, thereby contributing to production cost reduction.

Furthermore, in the above arrangement, the hook part is formed on the stimulating portion to allow the user to easily exert an external force to a local part of the users body in response to a user's pulling operation of the grip portion. With this arrangement, an effective finger-press-like sensation is obtainable at a desired local part of the user's body, e.g., a local part of the shoulder by pressing the hook part of the stimulating portion against the local part in response to a user's pulling operation of the grip portion, because the hook part has such a configuration as to easily transmit the external force from the grip portion to the stimulating portion.

This application is based on Japanese Patent Application No. 2004-010447 filed on Jan. 19, 2004, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. A massaging apparatus comprising:
a grip portion to be gripped by a user; and
a head portion provided on a top end of the grip portion, the head portion including:
a vibration generator for generating a vibration to vibrate the head portion;
a massaging roller;
a stimulating portion for giving a finger-press-like sensation to the user, the stimulating portion facing in the same direction as the massaging roller and being spaced apart from each other by a predetermined distance in an operating direction of the grip portion.

2. The massaging apparatus according to claim 1, wherein the head portion includes a pair of massaging rollers, and the respective axes of the massaging rollers are arranged in a direction perpendicularly intersecting the operating direction of the grip portion.

3. The massaging apparatus according to claim 1, wherein the massaging roller is arranged above the stimulating portion.

4. The massaging apparatus according to claim 3, wherein the most protruding point of the massaging roller and the most protruding point of the stimulating portion are on an imaginary body line.

5. The massaging apparatus according to claim 4, wherein a distance between the most protruding point of the massaging roller and the most protruding point of the stimulating portion is 70 to 80 mm.

6. The massaging apparatus according to claim 1, wherein the stimulating portion has a hook part for allowing the user to exert an external force to a local part of the user's body in response to a user's pulling operation of the grip portion in the operating direction.
